(19) United States
(12) Patent Application Publication
(10) Pub. No.: US 2005/0060227 A1
(43) Pub. Date: Mar. 17, 2005

(54) Advertising system

(76) Inventor: Robert W. Nelson, Ramona, CA (US)

Correspondence Address: FRANK G MORKUNAS, 7750 DAGGET ST, SUITE 203, SAN DIEGO, CA, 92111, US

(21) Appl. No.: 10/661,302

(22) Filed: Sep. 11, 2003

(51) Int. Cl. G06F 17/60

(52) U.S. Cl. 705/14

(57) ABSTRACT

An advertising system in which an advertising entity provides advertising space to a party for the advertisement of a subject matter and charges an advertising cost for the advertising space. The advertising cost to the party incrementally decreases while simultaneously incrementally increasing the amount of advertising space being provided as the party offers a discount to the asking price of the subject matter. The greater the discount off the asking price offered by the party, the greater amount of advertising space provided at a more reduced advertising cost.

### CROSS REFERENCES TO RELATED APPLICATIONS

None.

### STATEMENT REGARDING FEDERALLY-SPONSORED RESEARCH OR DEVELOPMENT

Not applicable.

### BACKGROUND OF THE INVENTION

This present invention relates to an improvement in methods of advertising, and more particularly to a method wherein the advertiser and the target of the advertiser each receive a monetary reward wherein the advertiser's reward is directly related to the target's reward. Advertiser's reward comprises decreased advertising costs and increased advertising space; and the target's reward is a discount to the merchant-advertiser's asking price for the subject matter of the transaction.

The invention comprises an advertising system tied to a reward [or discount rate] for the consumer which discounts the cost of the transaction to the consumer's benefit and at the same time, discounts the cost of the advertisement to the advertiser. The transaction may consist of the purchase or lease of a product or a service or both and a concomitant reward [discount in advertising cost and increase in advertising space] for the merchant seeking, by way of the advertisement, to consummate the transaction [to sell or rent the subject matter of the advertisement; i.e., product or service being sought by the consumer].

The advertising system can be used with any tangible medium capable of accepting an advertisement in any form and capable of being perceived, reproduced, or communicated, directly or indirectly, with or without the aid of a machine or device. Such tangible advertising medium may include, but is not limited to, hard-copy printed matter [as in newspapers, brochures, billboards, banners, and fliers], electronically transmitted, wired or wireless, medium [as in television, radio, telephone of any type, facsimile, any communication device], digitally conveyed medium, or any combinations thereof, and the like.

Though any such tangible medium is suited for the intended purpose, the internet is contemplated as the best medium for this advertising system. The term MERCHANT or ADVERTISER as used herein refers to a party, or agent of that party, wishing to initiate a transaction to sell or to rent goods or services or both [subject matter of the transaction or advertisement or both]; and the term CONSUMER as used herein refers to the entity desiring to buy or to rent the subject matter offered by the party-merchant.

Most advertising medium [i.e., newspapers, yellow pages, radio, television, etc.] charge fees generally based on the advertising space [i.e., size or duration or both of an ad and its circulation or exposure] multiplied by the number of ads being purchased by the merchant. Using size of ad alone, a one-inch ad in a daily newspaper may cost $100.00 per week; a two-inch ad in the same newspaper would cost more [approximately $200.00 per week]; and a three-inch ad may cost $300.00. If these ads were to run for two weeks, their respective total costs for the two-week run may be $200.00, $400.00, and $600.00.

Though some discounts to the advertising costs may be applied by the entity accepting the advertisement and placing the advertisement into the tangible medium of that entity, the advertising costs always increase with the increase in advertising space. For administrative clarity, this entity which accepts and places the advertisements into its source of tangible medium shall be referred to herein as “ad entity”. Most ad entities require a minimum ad space amount in order to accept an advertisement. This minimum ad space amount is referred to herein as basic space. Advertising space may be increased from the basic space to any overall space available to the ad entity; from a single one-inch ad, to a full-page ad, conceivably to virtually the entire tangible medium under the right conditions—but at an astronomical, if not prohibitive, cost. Naturally, more space, for a longer period of time, yields to the merchant a much greater exposure and, concomitantly, the greater likelihood of consummating a transaction and, hopefully, finalizing it. This has been common practice generally since advertising became a common staple in society.

The advertising system envisioned by the present invention, where ever and how ever employed, provides a discount in advertising cost to a merchant based on the amount of discount the merchant is willing to offer to the consumer on the subject matter of the transaction. The greater the discount offered to the consumer, the greater the exposure of the advertisement by increased advertising space and at an increasingly reduced advertising cost. This is a completely unprecedented approach to advertising and one which yields win-win results for all parties.

In this regard, if the merchant is not willing to offer any discount, the advertising cost to the merchant will not be discounted and the advertising space will be basic. As the merchant offers more discount to the asking price of the subject matter of the transaction, the advertising cost is incrementally discounted and may be discounted 100% thereby providing the advertisement to the merchant at no cost to the merchant. Not only is the advertising cost decreased but the advertising space given to the merchant, likewise, is incrementally increased. The advertising space may double in size, triple in size, quadruple in size, may include prioritized placement on a list of similar advertisements, may include enhanced and more exposure, and so on, such size and exposures limited on by the overall ad space available to the ad entity.

This inverse relationship between the advertising cost and the advertising space is truly novel and unique in the field of advertising; especially when tied to a discount in the merchant's asking price given to a consumer.

The foregoing has outlined some of the more pertinent aspects and objects of the present invention. These should be construed to be merely illustrative of some of the more prominent features and applications of the intended invention. Many other beneficial results can be attained by applying the disclosed invention in a different manner or by modifying the invention within the scope of the disclosure. Accordingly, other objects and aspects and a fuller understanding of the invention may be had by referring to the summary of the invention and the detailed description of the preferred embodiment in addition to the scope of the invention defined by the claims taken in conjunction with the accompanying drawings.

### BRIEF SUMMARY OF THE INVENTION

The above-noted problems, among others, are overcome by the present invention. Briefly stated, the present invention contemplates an advertising system which provides advertising space to a party for an advertisement of a subject matter and charges an advertising cost for the advertising space. The advertising cost to the party incrementally decreases while simultaneously incrementally increasing the amount of advertising space being provided as the party offers a discount to the asking price of the subject matter. The greater the discount off the asking price offered by the party, the greater amount of advertising space provided at a more reduced advertising cost.

The foregoing has outlined the more pertinent and important features of the present invention in order that the detailed description of the invention that follows may be better understood so the present contributions to the art may be more fully appreciated. Additional features of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the present invention. It also should be realized by those skilled in the art that such equivalent constructions and methods do not depart from the spirit and scope of the inventions as set forth in the appended claims.

### BRIEF DESCRIPTION OF THE DRAWINGS

For a fuller understanding of the nature and objects of the invention, reference should be had to the following detailed description taken in conjunction with the accompanying drawings in which:

FIG. 1 is a flow chart comprising the present invention.

FIG. 2 is a flow chart continuation of the flow chart in FIG. 1.

FIGS. 3A through 3C are bar graphs representing the prior art advertising system of ad space and ad costs.

FIGS. 4A through 4D are bar graphs representing the advertising system of the present invention as to ad space relative to ad cost and consumer discounts.

### DETAILED DESCRIPTION OF THE INVENTION

The advertising system envisioned by the present invention, as employable by any medium, provides a discount in advertising cost to a merchant based on the amount of discount off the merchant's asking price [AP] the merchant is willing to offer to the consumer [consumer discount (CD)] on the subject matter of the transaction. The greater the discount offered to the consumer, the greater the exposure of the advertisement by increased advertising space [AS] and at an increasingly reduced advertising cost [AC].

In the realm of the internet, increases to advertising space include, but are not limited to, increased byte size, insertion of banner ads, inclusion of pop-up ads, hyperlinks, ads or notices transmitted by e-mail [solicited by the recipient or unsolicited (SPAM)], personal digital devices or other similar devices, and to priority or order of listing [i.e., placement at the top of a list of similar listings thereby being the first being exposed to the viewer]. In the non-internet, traditional, realm of advertising, increases to advertising space typically include a larger advertisement in a flier, brochure, newspaper, magazine; a larger billboard sign or other signs and posters visible to the public; a longer commercial spot on television or radio; mailers; and the like.

The present invention contemplates and comprises uses in the traditional and non-traditional sense. In the non-traditional sense, the internet is the most capable of satisfying all facets of the present invention in the most efficient and effective manner—and virtually instantaneously. In the traditional sense, the process steps of the present invention are not eliminated, they are merely delayed. For this reason only, the following discussion uses the internet as the example, and example only, of the process steps of the present invention. Other medium are suited, but the internet is the most efficient and the preferred embodiment.

A typical internet application would require a user [consumer] to initiate an input or inquiry from a computer for a search/request for, by way of example, a residence rental unit at a certain geographic area of a certain amount of rooms or space at a certain monthly rate; connection to the internet with a suitable browser; and a server hosting a web-site wherein the web-site is capable of addressing the user's input search/request with a searchable database. It must be understood, however, that the subject matter of the transaction is not limited to residential or business rentals but also comprises sales or leases of all types of goods and/or all types of other services.

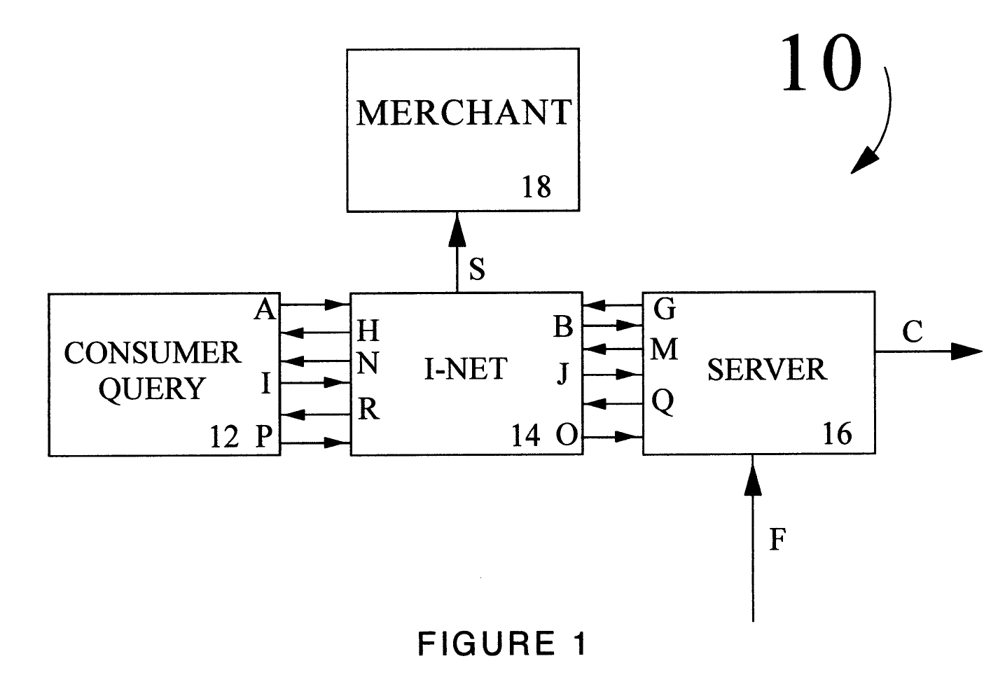

FIG. 1 illustrates the consumer inquiry as reference character 12, the internet as reference character 14, and the server as reference character 16. Arrow lines A to B to C [and the subsets of C] represent an initial Query [for the rental unit in the example set forth above]. The subsets of C will flow through C0, or through C1, or through C2, or through C3, or through C4, or through any subset as pre-determined and programmed.

The subset flow is determined by what, if any discount, is being offered by the merchant or sought by the consumer, and, which is incorporated into the advertising system 10 of the present invention. The sub-sets through which the inquiry flows for an answer include the discount being offered by the merchant to the consumer [Discount Levels 30, 32, 34, 36, 38] and will relate to the amount of space to be given to the merchant and at what cost [Ad Levels 20, 22, 24, 26, 28]. It is here that the server locates the subject matter sought by the consumer and conveys to the consumer that information along with all discounts being offered to the consumer by the merchant.

Unseen to the consumer are the ad costs to the merchant or the actual ad space being provided to the merchant. The discounts offered by the merchant will vary merchant to merchant and will vary subject matter to subject matter. The discounts are pre-determined to the extent that the merchant disclosures to the ad entity the consumer discount being offered and the ad entity presents the ad cost in relation to the ad space. The merchant may increase or decrease the consumer discount as the merchant pleases. As the consumer discount decrease, the ad cost will increase and the ad space will decrease. These components of ad cost to ad space tied to consumer discount are programmed into the server's data base and, except for the consumer discount, are hidden from the consumer.

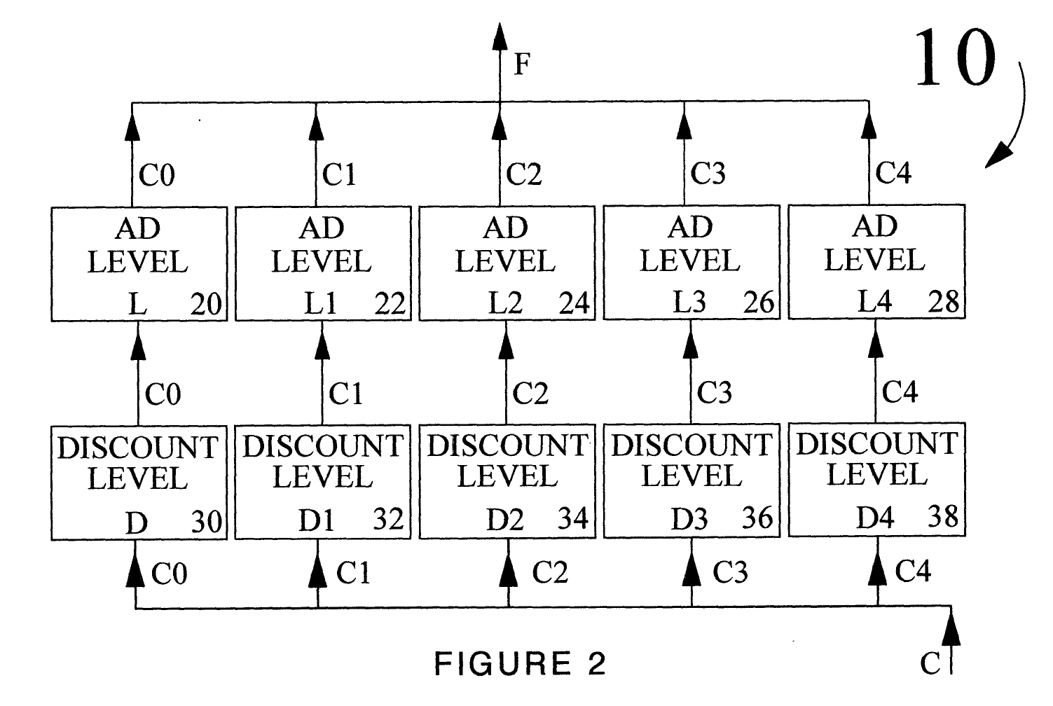

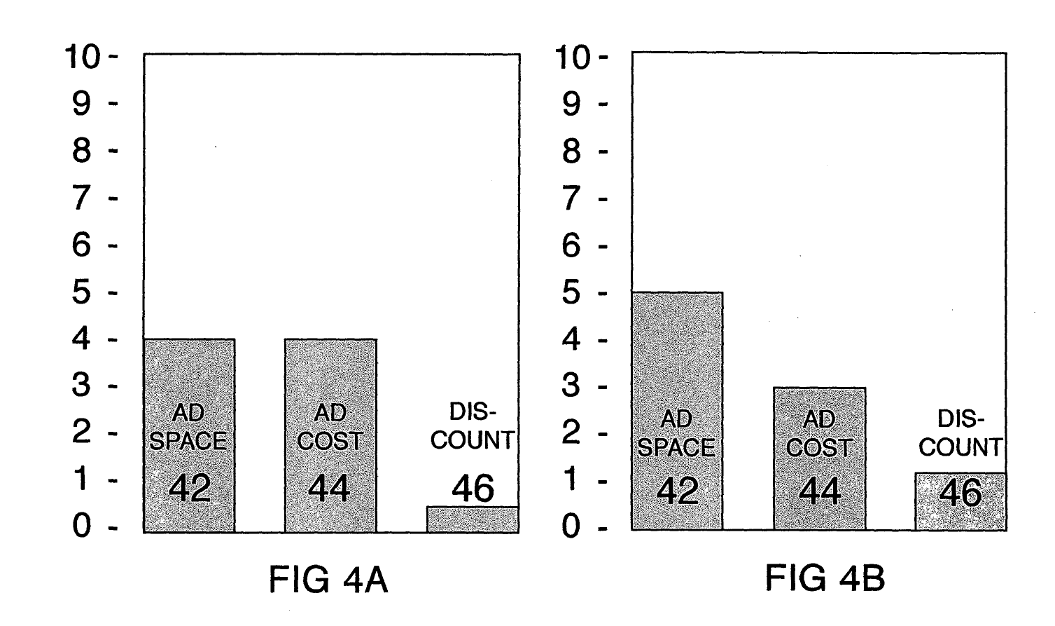

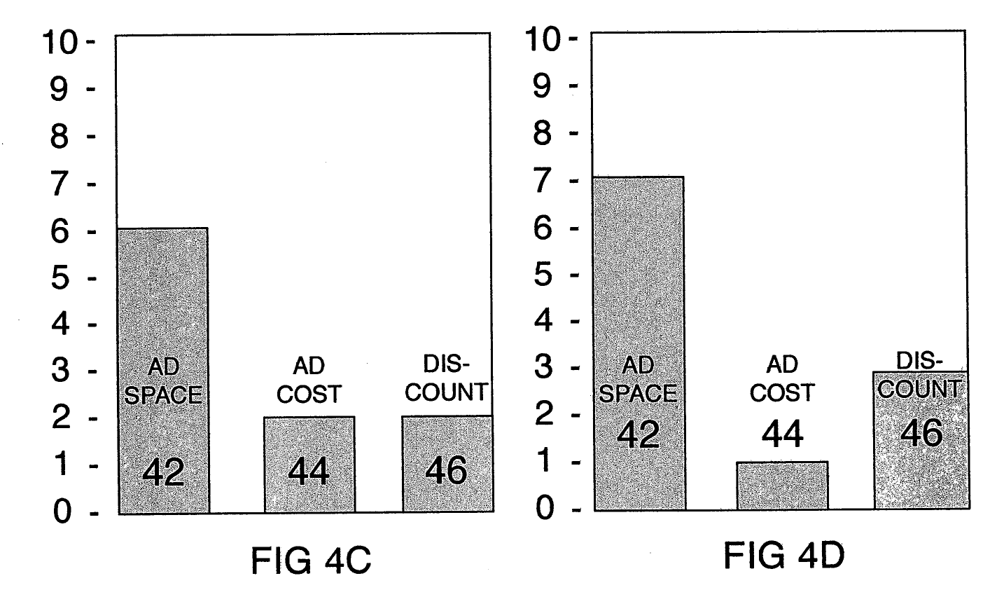

The illustrations of FIGS. 1 and 2 merely illustrate a flow of inquiry to retrieval to presentation to the consumer after the subject has been located and correlated to the consumer discount offered. These figures complement FIGS. 4A-4D which illustrates the relationship of ad space to ad cost to consumer discount and the concept of the present invention.

As illustrated in FIG. 2, the various Discount Levels may be level D 30, level D1 32, level D2 34, level D3 36, and level-D4 38. Each of these related discount levels are tied to respective Ad Levels such as level L 20, level L1 22, level L2 24, level L3 26, and level L4 28. Through the Server 16 the subject matter sought is located, with the discounts offered or requested, and passed on to the Consumer.

Lines F to G to H represent the Server's Answer to the Query along with the consumer discount, if any, which applies to that subject matter of the advertisement. All rental units, for example, matching the consumer's request are transmitted and conveyed to the consumer. Had the consumer requested a set discount amount, only those rental units offering such relative discounts would be conveyed to the consumer.

The Server 16 may have a web-site which provides up-front information to a user such as a listing of different discount levels associated with varying monthly rental costs. This could be based on percentages of discount relative to the monthly rental cost or could be pre-determined set discount amounts regardless of the monthly rental cost.

The various discount levels are illustrated in FIG. 2 and as previously mentioned are represented by D, D1, D2, D3, and D4. By way of example only level D reflects no discount, level D1 reflects some discount [for example 10% per month off the monthly rental cost or a pre-determined amount of $n where ‘n’ is the set amount], level D2 reflects more of a discount than that of level D1 [for example 20% per month off the monthly rental cost or a pre-determined amount of $n(×2)], level D3 reflects more of a discount than that of level D2 [for example 30% per month off the monthly rental cost or a pre-determined amount of $n(×3)], and so on. These consumer discounts [CD] to the asking price [AP] are strictly what the merchant is willing to provide and will vary case-by-case. The consumer discounts [CD] to the asking price [AP] are not determined by the ad entity. The ad entity merely incorporates the consumer discounts [CD] into the advertising system 10 which makes them retrievable, viewable, and available to an interested user. As mentioned above, it is the merchant who decides what consumer discount [CD] that merchant is willing to give to the consumer and it is that CD which will drive the ad cost and the ad space.

Lines I to J represent the consumer's Response to the Server's Answer. This response may be that the consumer is quitting the search without proceeding to consummate a transaction or it may be the consumer's indication that the consumer is willing to proceed forward with a view toward possibly consummating a transaction. If the former is the case, no further interaction ensues.

If the consumer is proceeding forward, lines M to N represent the Server's Reply to the Consumer's Response. This reply represents information requested from the consumer to be provided by the consumer to the requesting medium. Such information requested may include, but is not limited to, all personal information related to the consumer as to name, address, contact phone number[s], e-mail address[es], income level, profession, marital status, age, interests, hobbies, and the like; and may include a remarks or comments section for the consumer to add to or comment on anything.

Lines P to 0 represent the sought-after information being provided by the consumer. Once this information is received by the requesting medium [server 16 in this internet example], a certificate reflecting the discount amount is provided to the consumer. Lines Q to R represent the consumer discount certificate being conveyed to the consumer which corresponds to the subject matter of the advertisement. In this internet example, the discount certificate may be printed by the consumer and presented to the merchant which is to be applied to the asking price [AP] if the transaction is finalized; e.g., a rental contract is signed for the rental unit offered by the merchant.

After the information requested by the requesting medium is provided by the consumer to the requesting medium, the requesting medium also conveys this information to the merchant along with what subject matter is being sought by the consumer, and the discount amount as set forth in the discount certificate. The conveyance to the merchant of this information is represented by Line S. In addition, the merchant is informed of its cost-per-transaction of the merchant's advertisement as to this subject matter of the transaction.

The cost-per-transaction is a facet to advertising which is of utmost importance to any merchant and advertiser as it quantifies the advertisement-value and effectiveness; i.e., the actual cost of the advertisement based on interactive responses to the advertisement and consummation of the transaction. Consummation refers to a consumer providing the information requested and receiving the respective discount certificate [DC]. Consummation may instead entail finalization of the transaction (i.e., signing the rental contract); but it need not.

All advertisers would like to know whether or not their advertisements are effective and, not only reaching their target audience, buy garnering tangible results. Simply put, are the costs associated with ad placement worth it?

Cost-per-transaction [CPT] is derived from the advertisement cost [AC] divided by the number of discount certificates [DC] issued to one or more consumers on a specific subject matter of the advertisement. For example, in a setting where the landlord has five properties with the same characteristics [i.e., number of bedrooms, location, size, number of bathrooms], the landlord gives the consumer discount level selected by the landlord/advertiser, the advertising cost [AC] is $300 per month, and five discount certificates [DC] are issued.

In the above example, if five consumers sighting the advertisement, submit the information requested and receive a discount certificate, the cost-per-transaction is $300.00 [advertisement cost (AC)]÷5 [number of consumers requesting a consumer discount certificate (DC)]=$60.00 as the cost-per-transaction [or for strictly lease-related transactions, this is the cost-per-lease (CPL)]. The same formula applies where the advertiser is selling one or more of the same item and five, 10, or 20 consumers take the necessary steps to request a consumer discount certificate [DC] for that item [for strictly purchase-related transactions, this is the cost-per-sale (CPS)].

In operation, a merchant purchases an ad level from the ad entity [or server's operator]. As illustrated in FIG. 2, and briefly discussed, these ad levels range from level L [reference character 20] through level L4 [reference characters 22, 24, 26, 28, respectively]. Though only five levels are shown in FIG. 1, such levels are not limited to five in number and may extend to Level L_{N}. Each Ad Level, and ad cost [AC] therefor to the merchant, is tied to a corresponding Discount Level from level D through level D4 [represented by reference characters 30, 32, 34, 36, 38]. As with the ad levels, though only five levels are shown in FIG. 1, such levels are not limited to five in number and may extend to Level DN.

The Merchant determines what discount off the asking price [AP] the merchant is willing to offer to a consumer. The ad entity, based on the size of the discount, determines how much of a discount to the ad cost [AC] the ad entity will give to the merchant. The merchant may offer several tiers of consumer discount [CD] to a single subject matter, may offer only one predetermined amount for the consumer discount [CD] to a single subject, may offer several tiers of consumer discount [CD] to more than one subject matter, or may offer only one predetermined amount for the consumer discount to more than one subject matter, or any combination thereof. In instances where the consumer discount [CD] is pre-determined by the merchant, it is not necessarily the exact same amount for each one of the subject matters. Though pre-determined at the time offered, the merchant may modify the consumer discounts being offered. This, of course, would have the affect of decreasing the merchant's ad space and increasing the ad cost for that ad space.

Once the consumer discounts [CD] are established, the ad entity, based on the discounts offered, determines the ad cost [AC] and the ad cost [AC] will vary in an inverse relationship to the consumer discount [CD]. In other words, the ad cost [AC] is, to a great extent, controlled by the merchant since it incrementally decreases with each incremental increase the merchant provides to the consumer discount [CD]. With no consumer discount [CD], the discount level is level D; with some consumer discount [CD], the discount level is level D1; with more and more consumer discount [CD], the level move from level D1 to level D2, D2 to D3, and so on.

The ad cost [AC] moves inversely to the consumer discount [CD] and its level; AC decreases as the consumer discount [CD] and its level increases. By way of example, for level D [with no consumer discount] is AC [with no discount to the ad cost]; for level D1, the AC=AC−1; for level D2, the AC=AC−2; for level D3, the AC=AC−3; and for level D4, AC=the AC−4, where the digits ‘1’ through ‘4’ to the right of the minus-sign represent values other than the actual number for which they stand and those representative values may by pre-determined and fixed and are so pre-determined and fixed based on the consumer discount [CD] being offered.

In addition to a decrease in ad cost [AC], with each such decrease, the merchant is given an increase in the advertising space [AS]; that is, the size, scope, exposure, prioritized listing, and duration of the advertisement, for example. Consequently, as the merchant offers more and more of a consumer discount [CD], the ad entity gives to the merchant more and more of a discount to the ad cost [AC] which at the same time giving the merchant more and more ad space [AS].

By way of example only, not by means of limitation, for ad costs [AC] to a merchant dealing with apartment rental property, the AC for Discount Level D [with no consumer discount and at Ad Level L] is $170/year, for Discount Level D1 [with some consumer discount and at Ad Level L1] is $130/year, for Discount Level D2 [with a greater consumer discount than that which was provided in level D1 and at Ad Level L2] is $110/year, for Discount Level D3 [with a greater consumer discount than that which was provided in level D2 and at Ad Level L3] is $90/year, and for Discount Level D4 [with a greater consumer discount than that which was provided in level D3 and at Ad Level L4] is $70/year. As seen, the AC is directly tied to the consumer discount [CD] (i.e., the amount to be subtracted from the merchant's asking price [AP]) in which the merchant is willing to give to the consumer to buy or rent the merchant's goods or services.

In the example provided above [apartment rental ads], if the merchant is not willing to give any consumer discount [CD], that discount then is D or “0” and the merchant's cost for the ad is not reduced thereby making AC to equal AC [i.e., AC minus 0=AC or, by way of example, $170/year]. If the merchant is willing to give a Level D1 discount, the discount being D+1, then the cost for the ad is AC−1 [or $130/year]. The numeral to the right of the plus-sign in the discount levels represents the total amount of the consumer discount [CD]; whereas the numeral to the right of the minus-sign in the ad cost levels represents the total amount to be discounted from the ad cost. The numeral ‘1’ in this example for AC equals $40 and for CD [the consumer discount] it may equate to a total discount of between $100 to $300.

A Discount Level D2, being D+2 making the cost for the ad to be AC−2 [or $110/year]. The numeral ‘2’ in this example for AC equals $60 and for CD [the consumer discount] it may equate to a total discount of between $301 to $600. A Discount Level D3, being D+3 making the cost for the ad to be AC−3 [or $90/year]. The numeral ‘3’ in this example for AC equals $80 and for CD [the consumer discount] it may equate to a total discount of between $601 to $900. And finally, a Discount Level D4, being D+4 making the cost for the ad to be AC−4 [or $70/year]. The numeral ‘4’ in this example for AC equals $100 and for CD [the consumer discount] it may equate to a total discount of between $901 to $1200.

As expressed earlier and illustrated by example above, the greater the consumer discount [CD] off the asking price [AP] from the advertiser to the consumer [renter, user, buyer], the greater the discount from the ad entity to the merchant for advertisement cost [AC] to place the advertisement. Also the greater the consumer discount [CD] to the consumer off the asking price [AP] for the subject matter of the advertisement, the greater the amount of advertising space and exposure [AS] to the advertiser for the advertisement.

Continuing with the apartment rental example, the consumer makes an Query A which is transmitted to the Server B. The server returns information to the consumer by way of an Answer [arrows F to G to H]. In this Answer, the consumer sees various ads for apartment rentals corresponding to the consumer's Query as well as the typical information generally provided; i.e., location, size, number of rooms, amenities, monthly rate, and consumer discounts [CD], if any. Here the consumer may select a rental unit offering the Discount Level desired by the consumer.

In this example, the consumer Responds to the Server's Answer by selecting a rental unit offering a Discount Level D4 [arrows I to J]. Based on the consumer's Response, the Server Replies with a request for information [arrows M to N] which, if provided by the consumer are represented by arrows P to 0. After receiving the consumer information, the ad entity generate a discount coupon of between $901.00 and $1200.00 and transmits it to the consumer [arrows Q to R] to print out and to present to the merchant when, and if, finalizing the rental transaction. The consumer information also is provided to the merchant [arrow S].

If the transaction is finalized, the coupon amount is to be deducted from the total amounts due to the merchant over the life of the rental contract [e.g., rental cost of $1,000/month for a term of 12 months, yields a total amount to be paid by the consumer of $12,000 from which between $901 and $1200 is deducted either at inception or amortized over the duration of the rental contract] or, the merchant may as the discount offer the 13th month free to the consumer.

Using this system, both the merchant and the consumer benefit in that the price to consumer [consumer price (CP)] equals the asking price [AP] minus the consumer discount [CD] and the cost of the ad [ad cost (AC)] to the merchant also decreases as the CD increases.

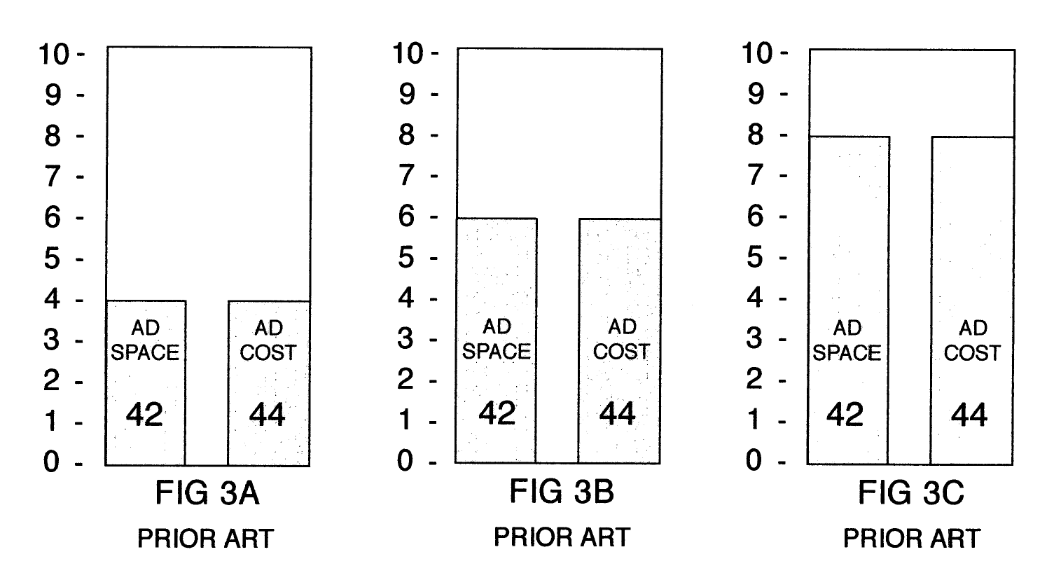

FIGS. 3A through 3C represent prior art advertising systems wherein as ad space [AS] 42 increases so too does the ad cost [AC] 44. FIGS. 4A through 4D represent the three-part concept of the present invention. In instances where a merchant offers no consumer discounts [CD] 46, the merchant receives no increased ad space [AS] 42 and no deduction from ad cost [AC] 44 as represented in FIG. 4A. Where some consumer discount [CD] 46 is offered, the ad space [AS] 42 increases and the ad cost [AC] decreases. The greater the consumer discount [CD], the ad space [AS] increases incrementally while the ad costs [AC] therefor decrease incrementally.

Simply put, the present invention reflects:
CP=AP−CD,
CD=AP−CP,
AP=CP+CD;
   and as:
AS ↑, AC ↓,
AC ↓, CP ↓,
AC ↓, CD ↑,
CD ↑, AS ↑,
CD ↑, AP ↓,
CD ↑, AC ↓;
   whereas the advertising systems of the prior art basically reflects that as:
AS ↑, AC ↑.

Consumer discounts [CD] may range from offering ‘none’ to as high as offering a 90% discount; or even greater at the discretion of the merchant. The ad cost [AC] will range from:
a. providing no discount to the AC while according only a basic space amount to the advertiser as the AS; to
b. providing up to a 100% discount to the AC and according greater space to the advertiser as the AS; up to a maximum amount of the overall space as is available by the ad entity.

Providing all the space available to the ad entity would be rare as space on the internet may be added as needed by the ad entity. It is not finite. Under the proper circumstances, however, the overall space is available and may be provided.

As the CD incrementally increases, the ad entity will incrementally increase the AS and incrementally decrease the AC.

The present disclosure includes that contained in the present claims as well as that of the foregoing description. Although this invention has been described in its preferred forms with a certain degree of particularity, it is understood that the present disclosure of the preferred form has been made only by way of example and numerous changes in the details of construction and combination and arrangement of system components and method steps may be resorted to without departing from the spirit and scope of the invention. Accordingly, the scope of the invention should be determined not by the embodiments illustrated, but by the appended claims and their legal equivalents.

1. An advertising system comprising the steps of:
providing advertising space to a party for an advertisement;
charging an advertising cost for said advertising space; and
incrementally decreasing said advertising cost for each incremental increase to said advertising space.

2. The advertising system of claim 1 wherein said advertising space comprises any tangible medium from which said advertisement is placable and from which said advertisement can be perceived, reproduced, or communicated either directly or with aid of a machine or a device.

3. The advertising system of claim 1 further comprises the step of offering one or more discount amount to a consumer on an asking price for a subject matter of said advertisement.

4. The advertising system of claim 3 further comprises the steps of said consumer selecting one or more of said one or more discount amount and providing information about said consumer to a requesting medium.

5. The advertising system of claim 4 further comprises the steps of said requesting medium conveying said information to said party and providing to said consumer a certificate reflecting said consumer's selection.

6. The advertising system of claim 5 further comprises the steps of compiling a report to said party wherein said report comprises a value between said advertising cost and a frequency of certificates provided on each subject matter of said advertisement.

7. The advertising system of claim 1 further comprises the step of receiving from said party a discount amount for a consumer to an asking price for a subject matter of said advertisement wherein a larger of said discount amount generates an increase in said advertising space and a decrease in said advertising cost.

8. The advertising system of claim 7 wherein said discount amount ranges from between none to approximately 90% of said asking price.

9. The advertising system of claim 8 wherein decreases to said advertising cost are between approximately none when said discount amount is none and up incrementally to 100% as said discount amount is incrementally increased.

10. The advertising system of claim 8 wherein increases to said advertising space over a basic space amount are between none when said discount amount is none and up incrementally, as overall space permits, as said discount amount is incrementally increased.

11. The advertising system of claim 1 further comprises the steps of compiling a report to said party wherein said report comprises a value between said advertising cost and a frequency of consumer requests for a discount to any asking price for any one subject matter of said advertisement.

12. An advertising system comprising the steps of:
providing advertising space to a party for an advertisement;
charging an advertising cost for said advertising space; and
receiving from said party one or more discount amount to an asking price for a subject matter of said advertisement and offering said one or more discount amount to a consumer, wherein each incrementally larger of said discount amount offered by said party to said consumer generates an incremental increase in said advertising space and an incremental decrease in said advertising cost.

13. The advertising system of claim 12 wherein said advertising space comprises any tangible medium from which said advertisement is placable and from which said advertisement can be perceived, reproduced, or communicated either directly or with aid of a machine or a device.

14. The advertising system of claim 12 wherein said discount amount ranges from between none to approximately 90% of said asking price.

15. The advertising system of claim 14 wherein decreases to said advertising cost are between approximately none when said discount amount is none and up incrementally to 100% as said discount amount is incrementally increased.

16. The advertising system of claim 14 wherein increases to said advertising space over a basic space amount are between none when said discount amount is none and up incrementally, as overall space permits, as said discount amount is incrementally increased.

17. The advertising system of claim 12 further comprises the steps of a consumer selecting one or more of said one or more discount amount and providing information about said consumer to a requesting medium.

18. The advertising system of claim 17 further comprises the steps of said requesting medium conveying said information to said party and providing to said consumer a certificate reflecting said consumer's selection.

19. The advertising system of claim 18 further comprises the steps of compiling a report to said party wherein said report comprises a value between said advertising cost and a frequency of certificates provided on each subject matter of said advertisement.
